(19) United States
(12) Patent Application Publication
(10) Pub. No.: US 2004/0028786 A1
(43) Pub. Date: Feb. 12, 2004

(54) Methods of freezing and thawing food, method of freezing, thawing, and cooking foods, devices for freezing and thawing food, device of freezing, thawing, and cooking food, and frozen food

(76) Inventors: Tomoko Tani, Osaka (JP); Hajime Oyabu, Osaka (JP); Toshiko Yasunobu, Osaka (JP); Mai Hashino, Osaka (JP); Masatoshi Inatani, Osaka (JP)

Correspondence Address: RATNERPRESTIA, P O BOX 980, VALLEY FORGE, PA, 19482-0980, US

(21) Appl. No.: 10/362,842

(22) PCT Filed: Jun. 10, 2002
(86) PCT No.: PCT/JP02/05717

(30) Foreign Application Priority Data
Jul. 3, 2001 (JP) 2001-202303

(51) Int. Cl. A23C 3/00

(52) U.S. Cl. 426/524

(57) ABSTRACT

A browning of a frozen food is prevented, when a frozen food is unfrozen. A method of freezing food, which includes a process of freezing food (S206 to S210), and a process of increasing a temperature of the food up to an enzyme deactivation temperature at which the enzyme browning the food is deactivated (S201 to S205), which is performed before the freezing process.

### TECHNICAL FIELD

The present invention relates to a food unfreezing method, an apparatus therefor and others, which prevent the discoloration of a food, when a frozen food is unfrozen, or a frozen food is unfrozen and then cooked.

### BACKGROUND ART

The food conservation functions of a refrigerator-freezer have been pursued. In recent years, of the conservation functions, a large number of techniques regarding quick-freezing have been developed, wherein a temperature zone of −1° C. to −5° C. that is the maximum ice crystal generation zone when a food is frozen, is quickly passed so as to conserve a frozen food at high quality, and thereby it has become possible to conserve a frozen food at high quality for a long time and to reduce the drip of frozen meat and fish when they are unfrozen. Thereafter, a new function of a refrigerator-freezer has been developed, which quickly cools a food from the hot state after heating or cools beverage with an ordinary temperature in a short time. These functions are considered as precooking functions of a refrigerator-freezer.

Moreover, Japanese Patent Laid-Open No. 4-73583 discloses a conventional technique of using a refrigerator not as a precooking apparatus but as a cooking apparatus. With this apparatus, after a food material is left in a frozen state for a certain period, the food material is immersed in a flavoring liquid and the temperature of the food material is then increased so as to promote the infiltration of the flavoring liquid into the food material, thereby preparing salted products. The configuration of this cooking apparatus will be explained by using FIG. 9.

In FIG. 9, Reference numeral 15 denotes a refrigerator-freezer low temperature cooking apparatus, which is configured by dividing a freezing chamber 16 and a cold storage chamber 17 with a dividing wall. Reference numeral 18 denotes a low temperature cooking chamber, which comprises a heat insulator 19 in a rim and an openable and closable door 20 in a frontal opening portion. Reference numeral 6 denotes cooling means consisting of a cooler 24, which is cooled by pressurizing a refrigerant with a compressor 21, liquefying the refrigerant with a condenser 22 and vaporizing the refrigerant with an expansion valve 23 at a burst. Air blasting means 25 forcedly ventilates the chilled air which is cooled by the cooling means 6 so as to send the chilled air to the low temperature cooking chamber 18 via a blast route 7. Reference numeral 8 denotes temperature controlling means such as a Damper Thermo, which is installed in the blast route 7 to maintain the low temperature cooking chamber 18 at an appropriate temperature. Moreover, heating means 2 consisting of an upper heater 26 and a lower heater 27 is provided in this cooking chamber 18. The lower heater 27 is a control panel which sets the temperature in the above low temperature cooking chamber 28 and the time, depending on a food material 29 in the low temperature cooking chamber 28. By setting these keys, an appropriate temperature control is carried out depending on each food material.

Thus, a user places the food material 29 in the low temperature cooking chamber 18, and then makes settings for the above food material 29, using the control panel 27, and thereby the chilled air cooled by the cooling means 6 is circulated into the above low temperature cooking chamber 18 by the air blasting means 25 and freezes the food material 29 for a certain period depending on the settings. Thereafter, the heating means 2 consisting of the upper and lower heaters 26 and 27 raises the temperature of the food material 29. Although no salts are added, plasmolysis occurs in the cell tissues of the food material and a flavoring material is infiltrated into the food material, thereby reducing salts and production time for salted products.

The conventional cooking apparatus is as described above. In a process where a food material is once frozen and then unfrozen, if the food material has a cell wall like vegetables, the cell wall is destroyed by the increase of water volume in the tissues when the food material is frozen, and the water is flown from the destroyed cell wall so that the food material becomes in the same state as salted products.

For example, when potato is used as a food material, if the potato is once frozen and then unfrozen, the surface of the potato is significantly browned. This is because tyrosine, a type of amino acid, which is an ingredient of potato, is exposed to the air, and oxidized with an enzyme tyrosinase as a catalyst. This browning is a phenomenon which occurs also when a potato peel is peeled normally and the surface is exposed. However, where the potato is once frozen and then unfrozen, since the intracellular tissues are flown outside, the amount of tyrosine and tyrosinase exposed to the air becomes larger than a case where the peel is simply peeled, and therefore the progressive level of browning becomes greater.

Accordingly, there has been a problem that, when a food which is once frozen is unfrozen, the frozen food is seriously damaged by browning.

### DISCLOSURE OF THE INVENTION

To solve the above described problem of the prior art technique, it is an object of the present invention to provide a food freezing method, a food unfreezing method, a food freezing apparatus, a food unfreezing apparatus and others, which unfreeze a frozen food material while preventing the browning of the frozen food material. It is another object of the present invention to provide a cooking method involving freezing and unfreezing a food, which uses the above described food freezing method, food unfreezing method and others.

To achieve the above object, the first invention of the present invention (corresponding to claim 1) is a food freezing method of freezing a food, which deactivates an enzyme existing in said food and browning said food before and/or during the freezing process.

A second invention of the present invention (corresponding to claim 2) is the food freezing method according to the first invention, wherein a deactivation of said enzyme is realized by increasing a temperature of said food up to an enzyme deactivation temperature at which the enzyme browning said food is deactivated.

A third invention of the present invention (corresponding to claim 3) is the food freezing method according to the first or the second invention, wherein said enzyme comprises all or a part of tyrosinase, polyphenol oxidase and phenol oxidase.

A fourth invention of the present invention (corresponding to claim 4) is the food freezing method according to the second invention, wherein said enzyme deactivation temperature is 80° C. or higher.

A fifth invention of the present invention (corresponding to claim 5) is the food freezing method according to any one of the first to the fourth inventions, wherein said food is in filtrated into a flavoring material before the freezing process.

A sixth invention of the present invention (corresponding to claim 6) is a food unfreezing method of unfreezing a frozen food, comprising a step of maintaining an atmosphere around said frozen food in a condition that the amount of oxygen becomes smaller than a predetermined amount at least during the process of unfreezing,

wherein said predetermined amount is a minimum amount, which is necessary for an enzyme browning said frozen food to brown said frozen food with said oxygen as a catalyst.

A seventh invention of the present invention (corresponding to claim 7) is the food unfreezing method according to the sixth invention, wherein the maintenance of said atmosphere is realized by making inert gas exist.

An eighth invention of the present invention (corresponding to claim 8) is a cooking method involving freezing and unfreezing a food, comprising a step of unfreezing a frozen food, which is frozen by the food freezing method at least according to any one of the first to the fifth inventions.

A ninth invention of the present invention (corresponding to claim 9) is a cooking method involving freezing and unfreezing a food, comprising at least a step of unfreezing a frozen food by the food unfreezing method according to the sixth or the seventh invention.

A tenth invention of the present invention (corresponding to claim 10) is the cooking method involving freezing and unfreezing a food according to the eighth or the ninth invention, wherein said step of freezing and said process of unfreezing are repeated at least once.

An eleventh invention of the present invention (corresponding to claim 11) is a food freezing apparatus, comprising a freezing means of freezing food,

wherein an enzyme existing in said food and browning said food is deactivated before and/or during the freezing operation performed by said freezing means.

A twelfth invention of the present invention (corresponding to claim 12) is a food freezing apparatus, comprising:

freezing means of freezing food; and

enzyme deactivating means of deactivating an enzyme existing in said food and browning said food before and/or during the freezing operation performed by said freezing means.

A thirteenth invention of the present invention (corresponding to claim 13) is the food freezing apparatus according to the twelfth invention, wherein said enzyme deactivating means increases the temperature of said food up to an enzyme deactivation temperature at which the enzyme browning said food is deactivated, before the freezing operation performed by said freezing means.

A fourteenth invention of the present invention (corresponding to claim 14) is the food freezing apparatus according to any one of the eleventh to the thirteenth inventions, wherein said enzyme comprises all or a part of tyrosinase, polyphenol oxidase and phenol oxidase.

A fifteenth invention of the present invention (corresponding to claim 15) is the food freezing apparatus according to the thirteenth invention, wherein said enzyme deactivation temperature is 80° C. or higher.

A sixteenth invention of the present invention (corresponding to claim 16) is a food unfreezing apparatus, comprising:

a storage chamber for containing a frozen food;

deaerating means of deaerating the inside of said storage chamber; and

unfreezing means of unfreezing said frozen food,

wherein said deaerating means maintains an atmosphere around said frozen food in a condition that the amount of oxygen becomes smaller than a predetermined amount at least during the unfreezing process, and

said predetermined amount is a minimum amount, which is necessary for an enzyme browning said frozen food to brown said frozen food with said oxygen as a catalyst.

A seventeenth invention of the present invention (corresponding to claim 17) is the food unfreezing apparatus according to the sixteenth invention, comprising inert gas introducing means of introducing inert gas into said storage chamber,

wherein the maintenance of said atmosphere is realized by making said inert gas exist.

An eighteenth invention of the present invention (corresponding to claim 18) is a cooking apparatus involving freezing and unfreezing a food, comprising:

the food freezing apparatus according to any one of the eleventh to the fifteenth inventions; and

infiltrating means of infiltrating said food into a flavoring material before the freezing process.

A nineteenth invention of the present invention (corresponding to claim 19) is a cooking apparatus involving freezing and unfreezing a food, comprising:

the food unfreezing apparatus according to the sixteenth or the seventeenth invention;

freezing means of freezing said food; and

infiltrating means of infiltrating said food into a flavoring material before the freezing process.

A twentieth invention of the present invention (corresponding to claim 20) is a frozen food obtained by freezing a food, wherein an enzyme browning said food is deactivated.

A twenty-first invention of the present invention (corresponding to claim 21) is the frozen food according to the twentieth invention, wherein a deactivation of said enzyme is realized by heating said food before and/or during the freezing process, so that the temperature of said food is increased up to an enzyme deactivation temperature at which the enzyme browning said food is deactivated.

A twenty-second invention of the present invention (corresponding to claim 22) is a program which allows a computer to execute the whole or part of the process of increasing the temperature of a food up to an enzyme deactivation temperature at which the enzyme browning said food is deactivated, in the food freezing method according to the first invention.

A twenty-third invention of the present invention (corresponding to claim 23) is a program which allows a computer to execute the whole or part of the process of maintaining an atmosphere around a frozen food in a condition that the amount of oxygen becomes smaller than an established amount at least during the unfreezing process in the food unfreezing method according to the sixth invention.

A twenty-fourth invention of the present invention (corresponding to claim 24) is a medium which carries a program allowing a computer to execute the whole or part of the process of increasing the temperature of a food up to an enzyme deactivation temperature at which the enzyme browning said food is deactivated, in the food freezing method according to the first invention.

A twenty-fifth invention of the present invention (corresponding to claim 25) is a medium which carries a program allowing a computer to execute the whole or part of the process of maintaining an atmosphere around a frozen food in a condition that the amount of oxygen becomes smaller than an established amount at least during the unfreezing process in the food unfreezing method according to the sixth invention.

An example of the above described present invention is a cooking apparatus involving freezing and unfreezing a food, which comprises a cooking chamber containing a food, cooling means of freezing the above food, heating means of unfreezing the above food, and temperature controlling means of controlling the temperature in the cooking chamber, wherein the above cooking chamber further comprises a container for hermetically containing a food, deaerating means of removing the air around the food by connecting to the above container, and gas in draft means of substituting inert gas for the air.

Moreover, another example of the present invention is a cooking apparatus involving freezing and unfreezing a food, wherein the heating means uses microwave.

Furthermore, another example of the present invention is a cooking method involving freezing and unfreezing a food, which repeats at least once two processes of a freezing process of freezing a food and an unfreezing process of unfreezing the food which is frozen by the above freezing process, and which further comprises a process of heating the food up to an enzyme deactivation temperature at which the enzyme associated with the discoloration of food is deactivated, before the above freezing process.

Still more, another example of the present invention is a cooking method involving freezing and unfreezing a food, which comprises a process of heating the food up to an edible temperature after the above freezing process.

Still further, another example of the present invention is a cooking method involving freezing and unfreezing a food, wherein the output of microwave is switched over in the middle of the above described heating process of the cooking method involving freezing and unfreezing a food.

Moreover, another example of the present invention is a cooking method involving freezing and unfreezing a food, which comprises a deaerating process of removing the air around the food during or before the above described freezing process.

Furthermore, another example of the present invention is a cooking method involving freezing and unfreezing a food, which comprises a gas substituting process of substituting inert gas for the air around the food during or before the above described freezing process.

### BRIEF DESCRIPTION OF THE DRAWINGS

FIG. 1 is a block diagram of a cooking apparatus involving freezing and unfreezing a food of Embodiment 1 of the present invention;

FIG. 2 is a flow sheet view of a cooking process by the cooking apparatus involving freezing and unfreezing a food of Embodiment 1 of the present invention;

FIG. 3 is a flow sheet view of a cooking process by the cooking apparatus involving freezing and unfreezing a food of Embodiment 1 of the present invention;

FIG. 4 is a flow sheet view of a second example of a cooking process by the cooking apparatus involving freezing and unfreezing a food of Embodiment 1 of the present invention;

FIG. 5 is a block diagram of a container with a deaeration function of the cooking apparatus involving freezing and unfreezing a food of Embodiment 2 of the present invention;

FIG. 6 is a flow sheet view of a cooking process by the cooking apparatus involving freezing and unfreezing a food of Embodiment 2 of the present invention;

FIG. 7 is a block diagram of a container with a gas injection function of the cooking apparatus involving freezing and unfreezing a food of Embodiment 3 of the present invention;

FIG. 8 is a flow sheet view of a cooking process by the cooking apparatus involving freezing and unfreezing a food of Embodiment 3 of the present invention; and

FIG. 9 is a block diagram of the conventional low temperature cooking apparatus.

### DESCRIPTION OF SYMBOLS

1 Cooking chamber

2 Heating means

3 Container

4 Weight sensor

5 Microcomputer

6 Cooling means

7 Blast route

8 Temperature controlling means

9 Temperature sensor

10 Deaerating means

11 Aspiration pomp

12 Tube

13 Air exhaust port

14 Gas injecting means

50 Container with deaeration function

70 Container with gas injection function

### BEST MODE FOR CARRYING OUT THE INVENTION

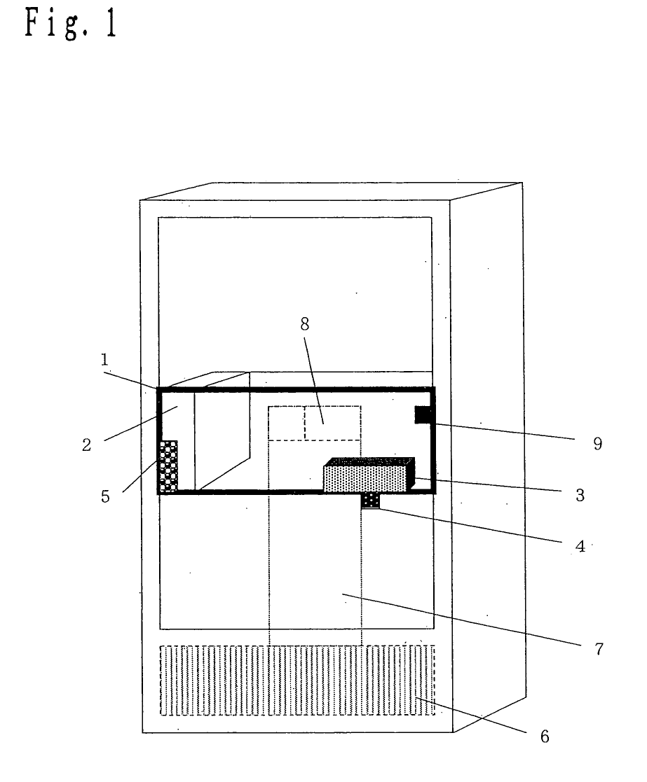

Referring to FIGS. 1 to 8, the embodiments of the present invention will be explained below. To carry out the present invention, the chilled air in a refrigerator can be used as means of cooling a food. Moreover, heating with a heater or microwave can be used as heating means. All of these means have conventionally been used, and therefore technical explanation on these means will be omitted in the present specification.

(Embodiment 1)

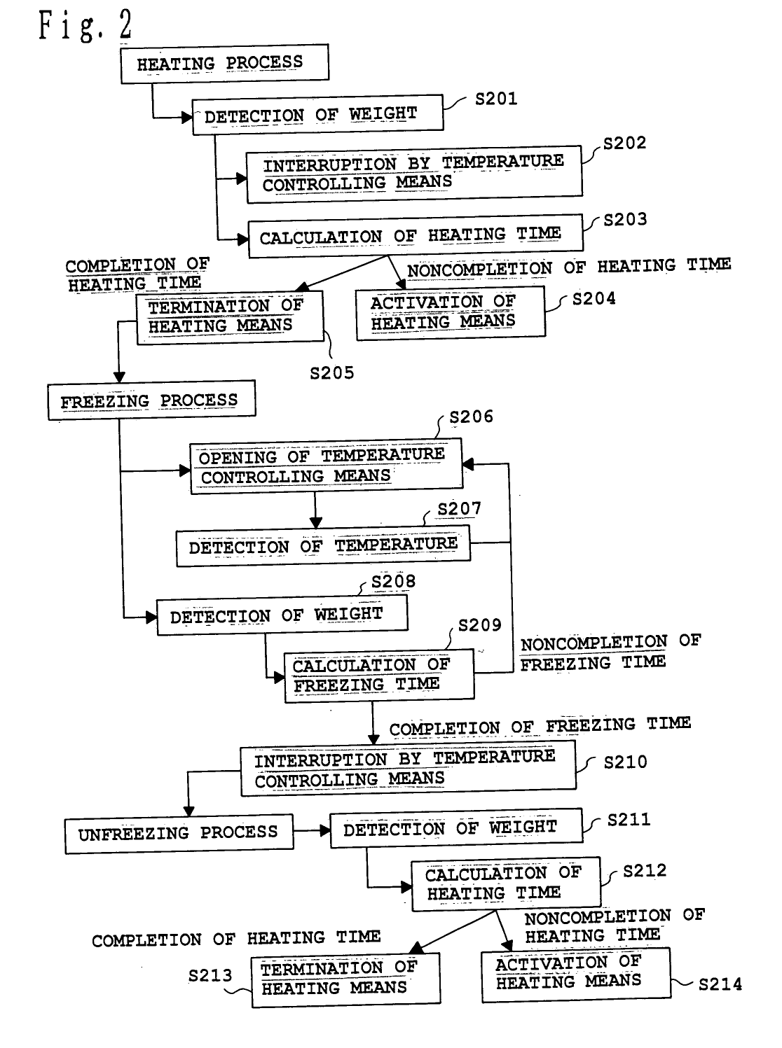

FIG. 1 is a block diagram of a cooking apparatus involving freezing and unfreezing a food of Embodiment 1 of the present invention, and FIG. 2 is a flow sheet view of a cooking process by the cooking apparatus involving freezing and unfreezing a food.

In FIG. 1, a cooking chamber 1 is comprised of a partition obtained by dividing the inside of a refrigerator with a heat insulator, and the cooking chamber comprises heating means 2 and a container 3. The heating means 2 is means of heating a food material placed in the container 3, and it consists of, for example, a magnetron outputting microwave or a heater. A microcomputer 5 operates a heating time on the basis of a detection signal from a weight sensor 4 which is installed at the bottom of the container 3, and then the heating means 2 actuates. Reference numeral 6 is cooling means of sending chilled air to each partition in the refrigerator, and the cooling means consists of a compressor for pressurizing a refrigerant, a condenser for liquefying the refrigerant, an expansion valve for vaporizing the liquefied refrigerant at a burst, and a cooler which is cooled by vaporization. The chilled air sent by the cooling means 6 is transferred to the cooking chamber 1 through a blast route 7. A temperature controlling means 8 is installed at an entrance located between the blast route 7 and the cooking chamber 1. The temperature controlling means 8 is realized by e.g. Damper Thermo, and actuates on the basis of a signal from a temperature sensor 9 installed in the cooking chamber 1, so that the inside of the cooking chamber is maintained at an appropriate temperature.

The operations of the cooking apparatus involving freezing and unfreezing a food of one embodiment of the present invention, which has the above configuration, will be explained while referring to the flow of FIG. 2, and further, one embodiment of the food freezing method and the cooking method involving freezing and unfreezing a food of the present invention will also be explained.

Taking potato as an example of a food, the cooking of potato samples will be explained. Initially, potatoes cut into four pieces and a mixed flavoring material are placed in the container 3.

The weight sensor 4 detects the weight of the container 3 and the pieces of potatoes and then transmits a signal to the microcomputer 5 (S201). In the microcomputer 5, the time when the temperature of a food reaches an enzyme deactivation temperature described later is previously set and input, depending on the weight of the food placed in the cooking chamber 1. After the microcomputer 5 calculates heating time on the basis of the signal transmitted (S203), the heating means 2 actuates (S204) While the heating means 2 actuates, the temperature controlling means 8 operates to interrupt between the cooking chamber and the blast route so that the chilled air generated by the cooling means 6 does not enter the inside of the cooking chamber 1 (S202).

After completion of the heating process, the weight sensor 4 detects the weight of the container 3 and the heated pieces of potatoes, and transmits a signal to the microcomputer 5 (S208). After the microcomputer 5 calculates freezing time on the basis of the signal transmitted (S209), the temperature controlling means 8 operates to connect the cooking chamber 1 with the blast route 7, so that the chilled air generated by the cooling means 6 can be introduced into the cooking chamber 1 (S206) Thereby, the inside of the cooking chamber 1 is cooled.

The temperature sensor 9 detects the temperature in the cooking chamber 1 (S207), and based on this, the temperature controlling means 8 introduces the chilled air generated by the cooling means 6 from the blast route 7 until the temperature in the cooking chamber reaches −5° C. After the temperature reaches −5° C., the cooking chamber is left for a certain time, and then conserved in an atmosphere of 0° C. until heating cooking is carried out.

Thus, the inside of the cooking chamber 1 is controlled to be maintained at −5° C. for a time set depending on the type and weight of a food. In addition, in the operations of the above S206 to S209, it may also be possible that the operation of S208 is omitted and the microcomputer 5 uses the weight data detected in S201 as is.

Next, in an unfreezing process, the weight sensor 4 detects the weight of the container 3 and the frozen pieces of potatoes, and then transmits a signal to the microcomputer 5 (S211). In the microcomputer 5, the time required for heating a food is previously set and input, depending on the weight of the food placed in the cooking chamber 1. After the microcomputer 5 calculates heating time on the basis of the signal transmitted (S212), the heating means 2 actuates (S214). While the heating means 2 actuates, the temperature controlling means 8 operates to interrupt between the cooking chamber 1 and the blast route 7, so that the chilled air generated by the cooling means 6 does not enter the inside of the cooking chamber 1 (S210). When the calculated heating time is completed, the heating means 2 terminates the operation so that unfreezing is completed. In addition, in the operations of the above S210 to S214, it may also be possible that the operation of S211 is omitted and the microcomputer 5 uses the weight data detected in S201 as is.

In the above described operations, when the potatoes are frozen in the freezing process, water in the cell tissues becomes ice, and the deformation or crack is occurred on the cell wall by expansion of volumes. Moreover, in the unfreezing process, the ice in the cells becomes water at that time, and the water is flown from the crack generated on the cell wall. Then, a mixing flavoring material is infiltrated into the cells of potato instead of the flown water.

When such frozen and unfrozen potatoes are heated, since the cell tissues of the potato become weak, these easily become soft, and so the cooking time becomes shorter than a normal heating cooking time. Moreover, since a mixed flavoring liquid is infiltrated into the cells when the potato is unfrozen, a well-tasted simmered dish can be prepared, although the heating time is short.

However, immediate after unfreezing frozen pieces of potatoes, the surface of them gets brown. As described above in the conventional example, this is because a type of amino acid, tyrosine, which is an ingredient of potato, is exposed to the air, and is oxidized with an enzyme tyrosinase as a catalyst. This browning is a phenomenon which occurs when a potato peel is peeled normally and the surface is exposed to the air. However, where the potato is once frozen and then unfrozen, since the ingredients in the cells are flown outside, the amount of tyrosine and tyrosinase exposed to the air becomes larger than a case where the outer peel is simply peeled, and therefore the degree of an advance of browning becomes greater.

In this embodiment, in order to prevent such a browning, an enzyme such as tyrosinase is deactivated in the above described heating process. When a somewhat generous amount of mixed flavoring liquid can be used in cooking, the interruption of the air becomes possible by completely immersing potatoes in the flavoring liquid. To the contrary, heating is carried out before the freezing process of cooking involving freezing and unfreezing a food so as to deactivate an enzyme. In the case of potato, heating is carried out so that the temperature of the food becomes 80° C. or higher.

By this heating process, the browning of a food material, which occurs from after cooking involving freezing and unfreezing a food until the performance of cooking by heating, can be prevented.

Examples of browned food materials other than potato include burdock, lotus root and others, and the browning of these food materials can also be prevented in cooking involving freezing and unfreezing a food by performing a heating process of heating the food materials up to a temperature of 80° C. or higher so as to deactivate an enzyme.

Examples of browned salted products among salted products which are eaten without heating, include salted leaf mustard, a salted Chinese cabbage, a cucumber pickle and others. In the normal preparation of salted products, salts are added to a food so as to run water contained in the food out. In contrast, in cooking involving freezing and unfreezing a food, since water contained in the food is run out by cytoclasis caused by the expansion of a volume of ice, which occurs when water in the food is frozen, unsalted products can be prepared without adding salts. However, when compared with the normal method of preparing salted products, in the cooking method involving freezing and unfreezing a food, ingredients in cells are likely to run out. In the case of a Chinese cabbage, oxidation is likely to occur when polyphenol oxidase in a polyphenol substance acts, whereas in the case of a cucumber or leaf mustard, the presence of oxygen and light causes the oxidation and decomposition of chlorophyll by active oxygen, and thereby the browning of these food materials is promoted.

Hence, even when salted product-like vegetable food which is eaten raw is prepared by the cooking method involving freezing and unfreezing a food, the browning of Chinese cabbage and the like can be prevented, if a heating process is added thereto. Moreover, even when a cucumber pickle-like or salted leaf mustard-like food is prepared, if a heating process of heating the food up to 70° C. is carried out before the freezing and unfreezing processes, an enzyme chlorophyllase acts to convert a green pigment chlorophyll into emerald green chlorophylline, and thereby the browning of food in cooking involving freezing and unfreezing a food can be prevented.

Table 1 shows examples of browned food, ingredients in the food causing browning, the type of enzymes which are causes for browning the food, and enzyme deactivation temperature (Based on “Study on cooking which takes advantage of food materials”, Kougaku Shuppan, written and edited by Naoko Tanabe).

TABLE 1

| | | | Enzyme |
|---|---|---|---|
| | Ingredient in | | deactivation |
| Food | food | Enzyme | temperature |
| Potato | Tyrosine, | Tyrosinase | 80° C. or |
| | Chlorogenic | | higher |
| | acid | | |
| Apple | Polyphenols | Polyphenol | |
| | | oxidase | |
| Lotus root | (Chlorogenic | Phenol oxidase | |
| | acid) | | |
| Burdock | | | |
| Eggplant | | | |
| Sweet | | | |
| potato | | | |

As shown in Table 1, enzymes browning the food include tyrosinase, polyphenol oxidase and phenol oxidase. This table shows that, in the cooking involving freezing and unfreezing a food of the present embodiment, when the food contains all or a part of these enzymes, the browning of the food can be prevented by setting the enzyme deactivation temperature at 80° C. or higher.

Where microwave is used in the heating means 2, a material through which the microwave is transmitted and which has a resistance to temperature is used as a container. An example includes polypropylene, which has a resistance to a temperature zone of −20° C. to 110° C. Where a heater is used in the heating means 2, a material having a good thermal-conductivity such as aluminum is used as a container so as to quickly transfer heat to a food.

Moreover, each of the freezing process and the unfreezing process is carried out once in the above operations, but these freezing and unfreezing processes may be repeated once or more times. Furthermore, it may also be possible to alter the temperature of the atmosphere around the potatoes, every time the freezing and unfreezing processes are repeated.

Further, the present invention may be realized as a food freezing method or food freezing apparatus used for a food, which is not unfrozen by the cooking apparatus involving freezing and unfreezing a food of the above Embodiment 1, but is unfrozen by another method of using external means such as a microwave oven or ordinary oven; and the food freezing method or apparatus comprises previously deactivating an enzyme contained in the food by the above described heating process, and then freezing the food. Still further, the flavoring material into which the food is immersed may not be used.

Moreover, the present invention may also be realized as a frozen food obtained by freezing a food, and for example, the frozen food may be realized as a frozen food wherein an enzyme contained in the food and browning the same is deactivated by the above described heating process.

Furthermore, in the above embodiment, a state of a food where an enzyme is deactivated is realized by heating the food, but in the present invention, such a state of a food where an enzyme is deactivated also be realized by another method.

The following operations are further carried out.

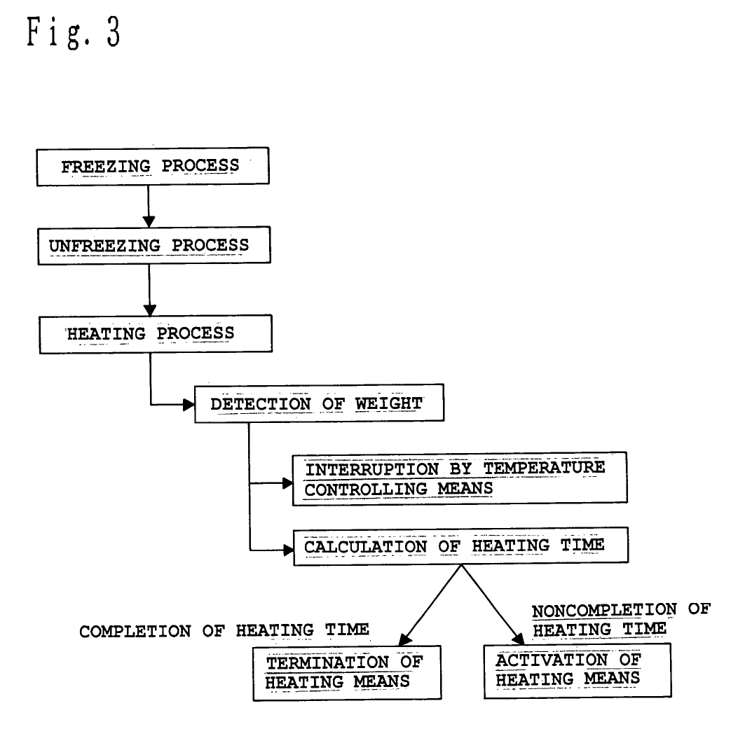

FIG. 3 is a flow sheet of a cooking process, which shows further operations of the cooking apparatus involving freezing and unfreezing a food of Embodiment 1 of the present invention, and in the flow, the heating process is carried out after an unfreezing process by the cooking apparatus involving freezing and unfreezing a food of Embodiment 1 of the present invention. Hereinafter, this point will be explained, while referring to figures.

A frozen and unfrozen food, which is subjected to a freezing process and an unfreezing process, is then eaten raw or cooked by an ordinary cooking method. The food in the latter case includes a simmered or grilled dish. In the case of a simmered dish which is transferred to a pan for cooking by heating after freezing and unfreezing processes, a heating process by heating means is carried out after the unfreezing process, as shown in the flow sheet of FIG. 3.

For the unfreezing process, a time when the temperature of a food reaches 0° C. by the heating means 2 is previously set, depending on the type and amount of the food. At the time when the time set for the unfreezing process passes over, the temperature controlling means 8 terminates and the heating means activates to perform the heating process. The heating time is calculated on the basis of the data detected by the weight sensor 4, so that a heating termination time is determined. After completion of the heating, the chamber is maintained at 5° C. by the temperature controlling means 8 so that conservation in an ordinary cold storage chamber can be performed, until the food is removed. Examples of a menu prepared by the above cooking process include seasoned beef with potato, chicken and vegetable fried and boiled with soy, boiled beans, boiled fish and others. If microwave is used in the heating means 2 to prepare these menus at a small amount, the heating is completed in a short time. Moreover, although the boiling time is short and the obtained cooking liquid is only a little, a well-tasted simmered dish can be prepared because a flavoring liquid is infiltrated into the food by freezing and unfreezing processes. Furthermore, since a heating process is incorporated into the cooking operations, a complicated operation of transferring a food into a pan to perform heating can be eliminated.

Further, the following operations may also be carried out.

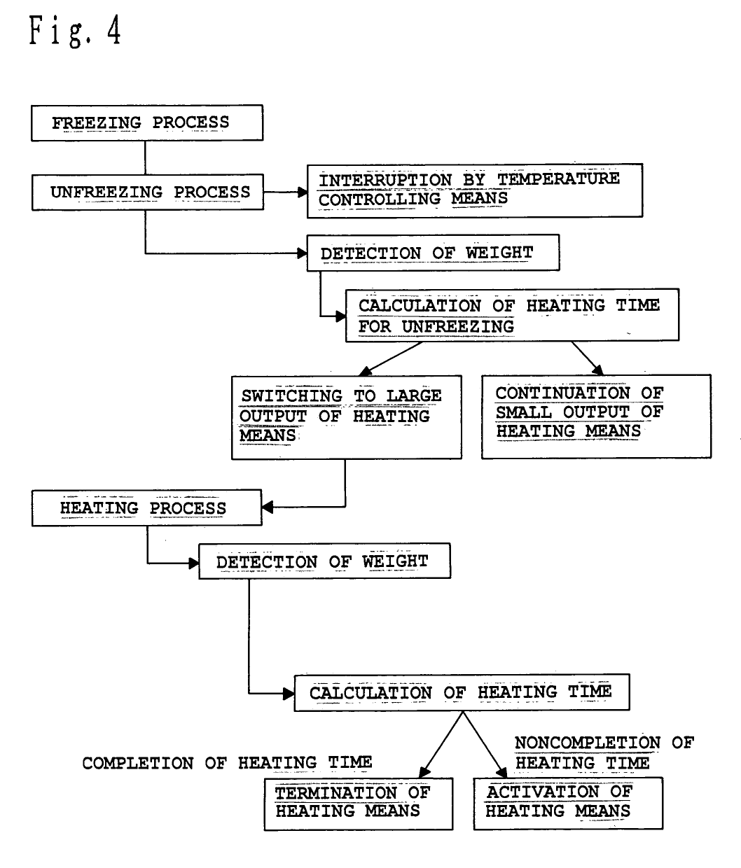

FIG. 4 is a flow sheet of a second example of a cooking process, which is another example of further operations of the cooking apparatus involving freezing and unfreezing a food of Embodiment 1 of the present invention. Heating by microwave is performed in the unfreezing and heating processes of the operations of the cooking apparatus involving freezing and unfreezing a food of Embodiment 1 of the present invention. A method of controlling the microwave will be explained.

In the unfreezing process, the power of microwave which enters a food is around 200W. Since the food is in a frozen state in the unfreezing process, when the frozen food is irradiated with the microwave, the microwave easily passes it through and it is difficult for the food itself to get hot. Further, when a part of the frozen food begins to melt, that part absorbs well the microwave, and this results in unevenness of heating. The greater the power of microwave irradiated, the more significantly this phenomenon appears. Therefore, the microwave of about 200W is continuously applied on the food until the food melts.

Thereafter, when the frozen food is completely unfrozen, the food is subjected to a heating process, in which the electric power of microwave is switched to about 500W to perform heating. With regard to the switching of the power of microwave, an unfreezing time is previously set and input in the microcomputer depending on the type and weight of the food. Otherwise, the switching can be carried out by grasping the change of the form of the food which is observed from the freezing period to the unfreezing period. For example, a food generating a cooking liquid generates the cooking liquid, as the food is unfrozen from the frozen state. The vibration which is generated when the liquid is come out is captured by a weight sensor, so that the power of microwave is switched. In the case of a food generating no cooking liquid, the vibration of water which is come out from vegetables when they are frozen, is captured by the weight sensor in a similar manner, so that the power of microwave is controlled. Thus, when heating is performed by switching the output of microwave between the frozen state and the unfrozen state of a food, the unevenness of microwave heating is controlled, and thereby the quality of the cooking involving freezing and unfreezing a food becomes good.

(Embodiment 2)

The cooking apparatus involving freezing and unfreezing a food of Embodiment 2 of the present invention is basically identical to that of Embodiment 1 of the present invention, but these apparatuses are different in that only the apparatus of Embodiment 2 has a function of removing the air from the container 3.

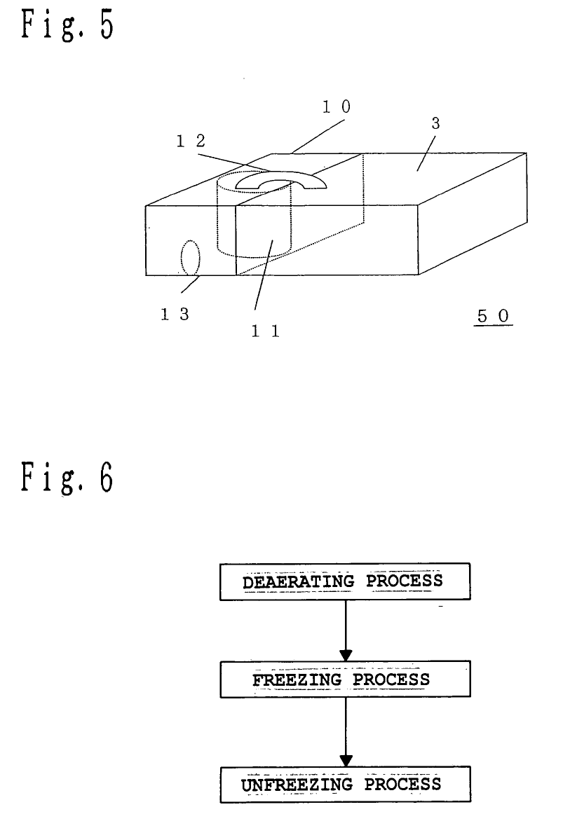

FIG. 5 is a block diagram of a container with a deaeration function of the cooking apparatus involving freezing and unfreezing a food of Embodiment 2 of the present invention, and FIG. 6 is a flow sheet view of a cooking process by this cooking apparatus involving freezing and unfreezing a food.

As shown in FIG. 5, a container 50 with a deaeration function is means having deaerating means 10 installed next to the container 3, and the deaerating means 10 contains an aspiration pomp 11 therein and comprises an air exhaust port 13. A tube 12 of the aspiration pomp 11 consists of a rubber tube or the like, and the tube is connected to the container 3 so as to connect the aspiration pomp 11 with the inside of the container 3.

The operations of the cooking apparatus involving freezing and unfreezing a food of Embodiment 2 of the present invention, which has the above described configuration, will be explained, so that one embodiment of the food freezing method and the cooking method involving freezing and unfreezing a food of the present invention will be explained. However, explanation on the parts overlapping with Embodiment 1 will be omitted, and differences will mainly be described.

Regarding the cooking apparatus involving freezing and unfreezing a food of the present embodiment, as shown in FIG. 6, in a series of operations such as a heating process, a freezing process and an unfreezing process of Embodiment 1, a deaerating process is carried out using the container 50 with a deaeration function instead of the heating process.

The deaerating process starts with the activation of the aspiration pomp 11, and by this, the air in the container 3 is aspirated and ejected from the air exhaust port 13 to the inside of the cooking chamber. At the time when the displacement reaches a certain amount, the operation of the aspiration pomp 11 is terminated. The detection of the displacement is carried out by connecting a flow meter or the like with the tube 12.

After completion of the deaerating process, the subsequent freezing and unfreezing processes are carried out in the same manner as described above in Embodiment 1. As explained in Embodiment 1, the browning of a food is caused by an enzyme and oxygen contained in the air around the food. In the present embodiment, the air around the food is removed, so that only the oxygen with an amount smaller than the amount necessary for the browning of a food can remain. Accordingly, the container 3 is filled with the amount of oxygen smaller than the amount necessary for browning, and therefore the browning reaction of a food does not occur after the unfreezing process starts, and the browning of a food such as potato or vegetable can be prevented. At this time, the deaerating process should only realize an atmosphere where the amount of oxygen around the food is smaller than the minimum amount of oxygen necessary for an enzyme contained in the food to brown the food, until at least the unfrozen food starts to get browned. Accordingly, a part of the deaerating process may be carried out paralleled with the freezing process.

In the above explanation, the operations consisting of three processes such as the deaerating process, the freezing process and the unfreezing process are carried out, but it may also be possible to add the heating process of Embodiment 1 between the deaerating process and the freezing process. At this time, a food material in the container 3 is heated up to an enzyme deactivation temperature while the food material is in a deaerated state, and thereby the effect of preventing browning can further be improved.

A method of detecting the residual amount of oxygen in the container 3 includes a detection method in which the change of the air pressure in the container 3 is detected using a pressure gage or the like, as well as a method of detecting the displacement. Moreover, the residual amount of oxygen may directly be detected, using a sensor.

(Embodiment 3)

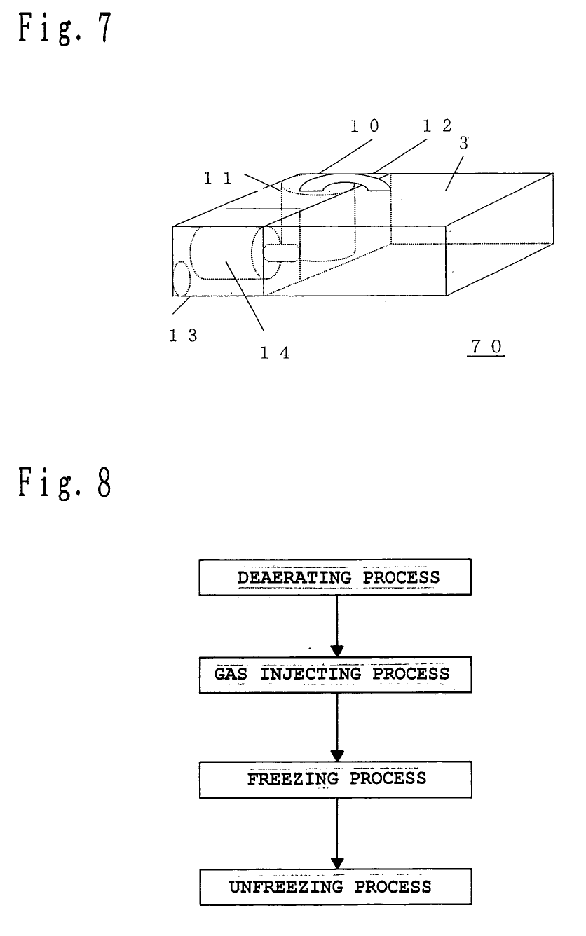

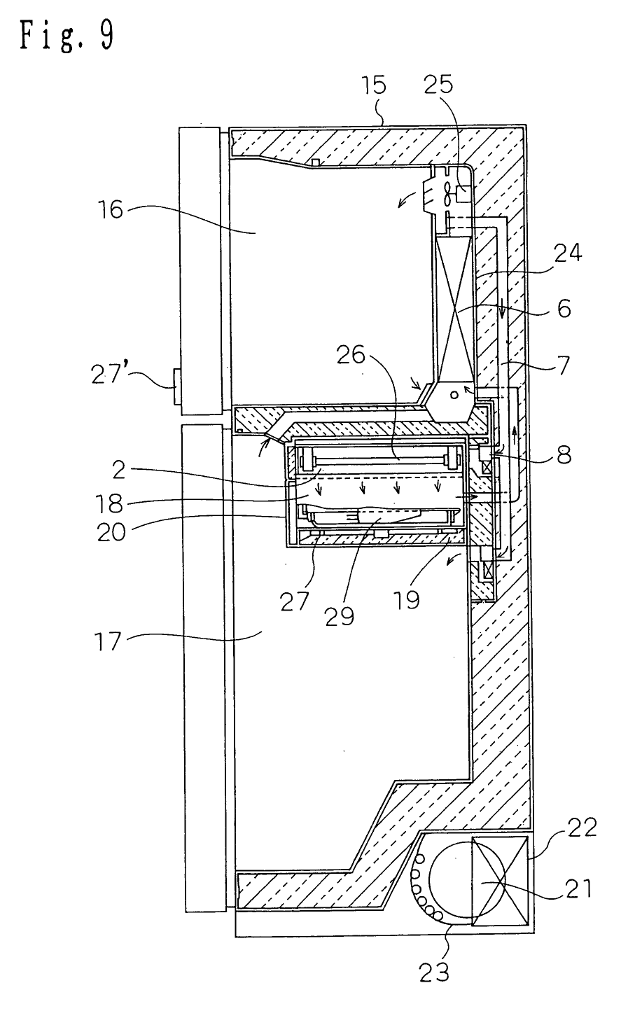

FIG. 7 is a block diagram of a container with a gas injection function of the cooking apparatus involving freezing and unfreezing a food of Embodiment 3 of the present invention, and FIG. 8 is a flow sheet view of a cooking process by this cooking apparatus involving freezing and unfreezing a food.

In FIG. 7, the identical numerals are assigned to the same portions or corresponding portions as in FIG. 5, and detailed explanation will be omitted. Reference numeral 14 is gas injecting means of injecting inert gas into the container 3. The gas injecting means 14 has a configuration in which a cartridge-type can detachable from the main body of the deaerating means 10 is set. Examples of inert gas include nitrogen and others.

As shown in FIG. 8, the operations of the cooking apparatus involving freezing and unfreezing a food of the present embodiment having the above described configuration, further comprise a gas injecting process of using a container 70 with a gas injection function between the deaerating process and the freezing process in the deaerating process, the freezing process and the unfreezing process of Embodiment 2. Accordingly, the same points as in Embodiment 2 will be omitted and the differences will mainly be described.

In the deaerating process, when the air is eliminated from the container 3 to such an extent that the amount of oxygen becomes smaller than the amount necessary for the browning of a food, inert gas is injected into the container 3 by the gas injecting means 14 in the gas injecting process, and thereby the container 3 is filled with the inert gas.

After completion of the gas injecting process, the subsequent freezing and unfreezing processes are carried out in the same manner as described above in Embodiment 1. The amount of oxygen in the container 3 becomes smaller than the amount necessary for browning by substituting inert gas for the air around the food, and therefore the browning reaction of the food does not occur after the unfreezing process starts, and further, the chemical change of food ingredients hardly occurs. Accordingly, not only the browning of a food but deterioration by the oxidation of food ingredients can also be prevented, and the doneness of the cooking involving freezing and unfreezing a food such as potato or vegetables becomes good.

In the above explanation, the operations consisting of four processes such as the deaerating process, the gas injecting process, the freezing process and the unfreezing process are carried out, but it may also be possible to add the heating process of Embodiment 1 between the gas injecting process and the freezing process or before the deaerating process, or paralleled with the deaerating processor the gas injecting process. At this time, a food material in the container 3 is heated up to an enzyme deactivation temperature in a state where inert gas is injected in the container, and thereby the effect of preventing browning can further be improved.

In each of the above described embodiments of the present invention, a cooking apparatus of freezing and unfreezing a food is provided, which comprises means of aspirating the air around the food or substituting inert gas for the air, and thereby the quality of the cooking involving freezing and unfreezing a food becomes good in that advantages are provided such that the browning of the food can be prevented and taste is well impregnated in the food.

Moreover, the use of microwave as the heating means in the cooking involving freezing and unfreezing a food makes possible completion of the cooking in a short time, when the amount of the food is small.

Furthermore, the heating process performed between the freezing and unfreezing processes can control the browning of a food caused by an action of an enzyme in the food, and thereby the quality of the cooking involving freezing and unfreezing a food becomes good.

Further, the heating process of heating a frozen food up to an edible temperature after the freezing process can eliminate a complicated operation of transferring a food into a pan to perform heating.

Still further, the heating is carried out by switching the output of microwave between the freezing process and the heating process in the cooking involving freezing and unfreezing a food, so that the unevenness of microwave heating can be controlled and thereby the quality of the cooking involving freezing and unfreezing a food becomes good.

Still further, the deaerating process of removing the air around a food is added during or before the above described freezing process, so that the air around the food can be removed and the browning of sliced vegetables can be prevented, and thereby the quality of the cooking involving freezing and unfreezing a food becomes good.

Still further, the air around a food is substituted by insert gas during or before the above described freezing process, so that the oxygen is removed, the chemical change of food ingredients hardly occurs, and both the browning of the food and deterioration caused by the oxidation of the food ingredients can be prevented, and thereby the doneness of the cooking involving freezing and unfreezing sliced vegetables becomes good.

It should be noted that, in each of the above described embodiments, the microcomputer 5 and the heating means 2 are shown as examples of the enzyme deactivating means and the unfreezing means of the present invention, the microcomputer 5 and the cooling means 6 are shown as examples of the freezing means of the present invention, the container 3 is shown as an example of the infiltrating means and the storage chamber of the present invention, the microcomputer 5 and the deaerating means 10 are shown as examples of the deaerating means of the present invention, and the microcomputer 5 and the gas injecting means 14 are shown as examples of the inert gas introducing means of the present invention.

It should also be noted that the present invention is not limited to the above described embodiments, and it is not always necessary that the storage chamber of the present invention serves both as the containing means and the infiltrating means for the cooking involving freezing and unfreezing a food, but it may contain a food frozen by other means such as an external freezing device. Therefore, the present invention may be realized not only for the cooking involving freezing and unfreezing a food, but also as a food unfreezing apparatus or a food unfreezing method, which unfreezes a food frozen by external means, at the time maintains an atmosphere around the food in a state where the amount of oxygen becomes smaller than the established amount, wherein the above established amount is the minimum amount that an enzyme browning the food using the oxygen as a catalyst needs to brown the above food.

Moreover, the present invention is a program, which allows a computer to execute operations in all or a part of the processes of the above described food unfreezing method or food freezing method of the present invention, and which operates cooperatively with the computer.

Furthermore, the present invention is a medium, which carries a program allowing a computer to execute all or a part of operations of all or a part of the processes of the above described food unfreezing method or food freezing method of the present invention, and which is computer-readable and wherein the above read program executes the above functions cooperatively with the above computer.

It should be noted that a part of the means (or devices, elements, circuits, parts etc.) of the present invention or a part of the steps (or processes, operations, actions, etc.) of the present invention are herein used to mean several means or steps among such a plurality of means or steps, or a part of functions or operations in a means or step. Moreover, a part of the devices (or elements, circuits, parts etc.) of the present invention are herein used to mean some devices among such a plurality of devices, a part of means (or elements, circuits, parts, etc.) in a device, or a part of functions in a means.

Further, the present invention also includes a computer-readable recording medium, which records the program of the present invention.

Furthermore, a usage form of the program of the present invention may be an aspect, in which the program is recorded in a computer-readable recording medium and operates cooperatively with the computer.

Still further, a usage form of the program of the present invention may be an aspect, in which the program is transmitted in a transmitting medium and then read by a computer, and operates cooperatively with the computer.

What is more, examples of the recording medium include ROM or the like, and examples of the transmitting medium include a transmitting mechanism such as the Internet or an optical fiber, a light, a radio wave, a sound wave, etc.

The above described computer of the present invention is not limited to pure hardware such as CPU, but may also include firmware, OS and peripheral equipment.

As stated above, the configuration of the present invention may be realized as software, or may be realized as hardware.

### INDUSTRIAL APPLICABILITY

As stated above, according to the present invention, the browning of a frozen food can be prevented, when the frozen food is unfrozen.

1. A food freezing method of freezing a food, which deactivates an enzyme existing in said food and browning said food before and/or during the freezing process.

2. The food freezing method according to claim 1, wherein a deactivation of said enzyme is realized by increasing a temperature of said food up to an enzyme deactivation temperature at which the enzyme browning said food is deactivated.

3. The food freezing method according to claim 1 or 2, wherein said enzyme comprises all or a part of tyrosinase, polyphenol oxidase and phenol oxidase.

4. The food freezing method according to claim 2, wherein said enzyme deactivation temperature is 80° C. or higher.

5. The food freezing method according to any one of claims 1 to 4, wherein said food is infiltrated into a flavoring material before the freezing process.

6. A food unfreezing method of unfreezing a frozen food, comprising a step of maintaining an atmosphere around said frozen food in a condition that the amount of oxygen becomes smaller than a predetermined amount at least during the process of unfreezing,
wherein said predetermined amount is a minimum amount, which is necessary for an enzyme browning said frozen food to brown said frozen food with said oxygen as a catalyst.

7. The food unfreezing method according to claim 6, wherein the maintenance of said atmosphere is realized by making inert gas exist.

8. A cooking method involving freezing and unfreezing a food, comprising a step of unfreezing a frozen food, which is frozen by the food freezing method at least according to any one of claims 1 to 5.

9. A cooking method involving freezing and unfreezing a food, comprising at least a step of unfreezing a frozen food by the food unfreezing method according to claim 6 or 7.

10. The cooking method involving freezing and unfreezing a food according to claim 8 or 9, wherein said step of freezing and said process of unfreezing are repeated at least once.

11. A food freezing apparatus, comprising a freezing means of freezing food,
wherein an enzyme existing in said food and browning said food is deactivated before and/or during the freezing operation performed by said freezing means.

12. A food freezing apparatus, comprising:
freezing means of freezing food; and
enzyme deactivating means of deactivating an enzyme existing in said food and browning said food before and/or during the freezing operation performed by said freezing means.

13. The food freezing apparatus according to claim 12, wherein said enzyme deactivating means increases the temperature of said food up to an enzyme deactivation temperature at which the enzyme browning said food is deactivated, before the freezing operation-performed by said freezing means.

14. The food freezing apparatus according to any one of claims 11 to 13, wherein said enzyme comprises all or a part of tyrosinase, polyphenol oxidase and phenol oxidase.

15. The food freezing apparatus according to claim 13, wherein said enzyme deactivation temperature is 80° C. or higher.

16. A food unfreezing apparatus, comprising:
a storage chamber for containing a frozen food;
deaerating means of deaerating the inside of said storage chamber; and
unfreezing means of unfreezing said frozen food,
wherein said deaerating means maintains an atmosphere around said frozen food in a condition that the amount of oxygen becomes smaller than a predetermined amount at least during the unfreezing process, and
said predetermined amount is a minimum amount, which is necessary for an enzyme browning said frozen food to brown said frozen food with said oxygen as a catalyst.

17. The food unfreezing apparatus according to claim 16, comprising inert gas introducing means of introducing inert gas into said storage chamber,
wherein the maintenance of said atmosphere is realized by making said inert gas exist.

18. A cooking apparatus involving freezing and unfreezing a food, comprising:
the food freezing apparatus according to any one of claims 11 to 15; and
infiltrating means of infiltrating said food into a flavoring material before the freezing process.

19. A cooking apparatus involving freezing and unfreezing a food, comprising:
the food unfreezing apparatus according to claim 16 or 17;
freezing means of freezing said food; and
infiltrating means of infiltrating said food into a flavoring material before the freezing process.

20. A frozen food obtained by freezing a food, wherein an enzyme browning said food is deactivated.

21. The frozen food according to claim 20, wherein a deactivation of said enzyme is realized by heating said food before and/or during the freezing process, so that the temperature of said food is increased up to an enzyme deactivation temperature at which the enzyme browning said food is deactivated.

22. A program which allows a computer to execute the whole or part of the process of increasing the temperature of a food up to an enzyme deactivation temperature at which the enzyme browning said food is deactivated, in the food freezing method according to claim 1.

23. A program which allows a computer to execute the whole or part of the process of maintaining an atmosphere around a frozen food in a condition that the amount of oxygen becomes smaller than an established amount at least during the unfreezing process in the food unfreezing method according to claim 6.

24. A medium which carries a program allowing a computer to execute the whole or part of the process of increasing the temperature of a food up to an enzyme deactivation temperature at which the enzyme browning said food is deactivated, in the food freezing method according to claim 1.

25. A medium which carries a program allowing a computer to execute the whole or part of the process of maintaining an atmosphere around a frozen food in a condition that the amount of oxygen becomes smaller than an established amount at least during the unfreezing process in the food unfreezing method according to claim 6, in the food unfreezing method according to claim 6.
